(19) United States
(12) Patent Application Publication
(10) Pub. No.: US 2026/0155141 A1
(43) Pub. Date: Jun. 4, 2026

(54) METHOD FOR GENERATING SPEECH FEATURE DESCRIPTION, APPARATUS, ELECTRONIC DEVICE, AND STORAGE MEDIUM

(71) Applicant: BAIDU INTERNATIONAL TECHNOLOGY (SHENZHEN) CO., LTD., Shenzhen (CN)

(72) Inventors: Xiaolong Lin, Shenzhen (CN); Di Su, Shenzhen (CN)

(73) Assignee: BAIDU INTERNATIONAL TECHNOLOGY (SHENZHEN) CO., LTD., Shenzhen (CN)

(21) Appl. No.: 19/459,829

(22) Filed: Jan. 26, 2026

(30) Foreign Application Priority Data
Jun. 23, 2025 (CN) 202510850301.1

(51) Int. Cl. G10L 15/197; G10L 15/02

(52) U.S. Cl. CPC G10L 15/197; G10L 15/02

(57) ABSTRACT

A method for generating speech feature description, an apparatus, an electronic device, and a storage medium are provided. The method includes: acquiring target speech data; recognizing the target speech data to obtain a plurality of speech attribute labels of the target speech data; determining a target speech attribute label from the plurality of speech attribute labels; and generating natural language description information corresponding to the target speech data according to the target speech attribute label, in which the natural language description information is used to describe speech features of the target speech data.

### CROSS-REFERENCE TO RELATED APPLICATIONS

The present disclosure is based upon and claims priority to Chinese Patent Application No. 2025108503011, filed on Jun. 23, 2025, the entire content of which is incorporated herein by reference for all purposes.

### FIELD

The present disclosure relates to the field of computer technology, and in particular, to the field of artificial intelligence such as speech technology and large models, specifically to a method for generating speech feature description, an apparatus, an electronic device, and a storage medium.

### BACKGROUND

With the development of artificial intelligence, a speech technology is being increasingly widely applied in daily life. For example, in online meeting scenarios, a voice can be captured and converted into text in real time for users. Similarly, in the field of search, voice inputs from users can be recognized to determine their search intent.

### SUMMARY

According to a first aspect of the present disclosure, a method for generating a speech feature description is provided, including:
acquiring target speech data;
recognizing the target speech data to obtain a plurality of speech attribute labels of the target speech data;
determining a target speech attribute label from the plurality of speech attribute labels; and
generating natural language description information corresponding to the target speech data according to the target speech attribute label, in which the natural language description information is used to describe speech features of the target speech data.

According to another aspect of the present disclosure, an apparatus for generating a speech feature description is provided, including:
a first acquisition module, configured to acquire target speech data;
a recognition module, configured to recognize the target speech data to obtain a plurality of speech attribute labels of the target speech data;
a first determination module, configured to determine a target speech attribute label from the plurality of speech attribute labels; and
a first generation module, configured to generate natural language description information corresponding to the target speech data according to the target speech attribute label, in which the natural language description information is used to describe speech features of the target speech data.

According to another aspect of the present disclosure, an electronic device is provided, including:
at least one processor; and
a memory communicatively connected to the at least one processor, in which the memory stores instructions executable by the at least one processor, and the instructions, when executed by the at least one processor, cause the at least one processor to perform the method according to the aforementioned embodiments.

According to another aspect of the present disclosure, a non-transitory computer-readable storage medium storing computer instructions is provided, in which the computer instructions are used to cause a computer to perform the method according to the aforementioned embodiments.

According to another aspect of the present disclosure, a computer program product is provided, including a computer program, in which the computer program, when executed by a processor, implements the method according to the aforementioned embodiments.

It should be understood that the content described in this section is not intended to identify key or essential features of the embodiments of the present disclosure, nor is it intended to limit the scope of the present disclosure. Other features of the present disclosure will become apparent from the following description.

### BRIEF DESCRIPTION OF THE DRAWINGS

The drawings are provided to facilitate a better understanding of the present solution and do not constitute a limitation to the present disclosure.

FIG. 1 is a schematic flowchart of a method for generating a speech feature description according to an embodiment of the present disclosure.

FIG. 2 is a schematic flowchart of a method for generating a speech feature description according to another embodiment of the present disclosure.

FIG. 3 is a schematic flowchart of a method for generating a speech feature description according to another embodiment of the present disclosure.

FIG. 4 is a schematic flowchart of a method for generating a speech feature description according to another embodiment of the present disclosure.

FIG. 5 is a schematic structural diagram of an apparatus for generating a speech feature description according to an embodiment of the present disclosure.

FIG. 6 is a block diagram of an electronic device for implementing the method for generating a speech feature description according to an embodiment of the present disclosure.

### DETAILED DESCRIPTION

The following describes exemplary embodiments of the present disclosure with reference to the drawings. Various details of the embodiments of the present disclosure are included to facilitate understanding, and they should be considered merely exemplary. Therefore, those of ordinary skill in the art should appreciate that various changes and modifications may be made to the embodiments described herein without departing from the scope and spirit of the present disclosure. Likewise, for clarity and conciseness, descriptions of well-known functions and structures are omitted in the following description.

It should be noted that the acquisition, storage, use, processing, etc. of data in the present disclosure comply with relevant provisions of national laws and regulations and do not violate public order and good morals.

The method for generating a speech feature description, the apparatus, the electronic device, and the storage medium according to embodiments of the present disclosure are described below with reference to the drawings.

In some scenarios, for speech data, it may be necessary to extract information such as speaker information, sound information, and emotional information, and describe the speech features of the speech data based on these information. Based on this, embodiments of the present disclosure provides a method for generating a speech feature description.

FIG. 1 is a schematic flowchart of a method for generating a speech feature description according to an embodiment of the present disclosure.

The method for generating a speech feature description according to embodiments of the present disclosure may be performed by an apparatus for generating a speech feature description according to embodiments of the present disclosure, and the apparatus may be configured in an electronic device.

The electronic device may be any device with computing capabilities, such as a personal computer, a mobile terminal, a server, etc. The mobile terminal may be, for example, a vehicle-mounted device, a mobile phone, a tablet computer, a personal digital assistant, a wearable device, or other hardware devices equipped with various operating systems, touch screens, and/or display screens.

As shown in FIG. 1, the method for generating a speech feature description includes:

Step 101: acquiring target speech data.

In the present disclosure, the target speech data may be any speech data. For example, the target speech data may be speech data collected in real time by an audio acquisition device, or audio data extracted from audio-video data, or speech data obtained by preprocessing original speech data, or speech data obtained through other means, which is not limited herein.

In an embodiment, voice activity detection may be performed on the original speech data to remove silent segments, thereby obtaining the target speech data. Thus, by removing silent segments from the speech data through the voice activity detection, the impact of silence on the calculation of global volume, pitch, speech rate, etc., can be avoided.

Step 102: recognizing the target speech data to obtain a plurality of speech attribute labels of the target speech data.

The speech attribute labels may be used to identify the speaker's age, gender, accent, speech rate, pitch, volume, degree of voice fluctuation, emotion, etc.

Exemplarily, the speech attribute labels may include, but are not limited to, an age label, a gender label, an accent label, a speech rate label, a pitch label, a volume label, an emotion label, etc.

For example, the age label may include child, teenager, youth, middle-aged, elderly, etc. The speech rate label may include slow speech rate, normal speech rate, fast speech rate, etc.

For instance, the plurality of speech attribute labels of the target speech data may include youth, high volume, fast speech rate, intense emotion, etc.

In the present disclosure, for different speech attributes, corresponding recognition strategies matching the speech attributes may be employed based on the target speech data to determine the speech attribute labels.

In an embodiment, a pre-trained speech representation learning model may be used to recognize the target speech data to determine speech attribute labels for identifying the speaker's age, gender, accent, etc.

In an embodiment, a speech rate value may be calculated based on text obtained by performing a speech recognition on the target speech data, and a corresponding speech rate label may be determined according to the calculated speech rate value.

For example, the speech rate value may be determined according to a ratio between the total number of phonemes and the speech duration. Then, based on the speech rate value and the speech rate range corresponding to each speech rate label, the speech rate label for the target speech data may be determined. For instance, a speech rate value less than 40% corresponds to a speech rate label “slow speech rate”, a speech rate value greater than 60% corresponds to a speech rate label “fast speech rate”, a speech rate value greater than or equal to 40% and less than or equal to 60% corresponds to a speech rate label “normal speech rate”, and so on.

In an embodiment, a volume value of the target speech data may be calculated, and a volume label may be determined according to the volume value, such as low volume, normal volume, high volume, etc.

In an embodiment, a pitch value of the target speech data may be calculated, and a pitch label may be determined according to the pitch value and pitch data for different genders, such as low pitch, normal pitch, high pitch, etc.

In an embodiment, a degree of voice fluctuation may be determined based on the variance of pitch values.

In an embodiment, a pre-trained emotion recognition model may be used to recognize the target speech data to determine an emotion label corresponding to the target speech data, etc.

Step 103: determining a target speech attribute label from the plurality of speech attribute labels.

To improve information focus, in the present disclosure, the plurality of speech attribute labels may be filtered to determine the target speech attribute label from the plurality of speech attribute labels.

The target speech attribute label may be one or more, which is not limited in the present disclosure.

In an embodiment, the target speech attribute label may be determined from the plurality of speech attribute labels according to attribute information of the speech attribute labels. The attribute information of a speech attribute label may be data used to describe characteristics of the speech attribute label.

Exemplarily, the attribute information of a speech attribute label may include, but is not limited to, a sampling probability corresponding to the speech attribute label, a quantized value corresponding to the speech attribute label, whether the speech attribute label is a neutral attribute label, etc.

The sampling probability corresponding to a speech attribute label may refer to a probability of the speech attribute label being selected.

Regarding the quantized value corresponding to a speech attribute label, for example, the quantized value corresponding to a speech rate label is a speech rate value, and the quantized value corresponding to a volume label is a volume value, etc.

A neutral attribute label refers to an attribute label without inclination, such as normal speech rate, normal volume, normal pitch, etc., all belong to neutral attribute labels.

Exemplarily, other speech attribute labels among the plurality of speech attribute labels excluding the neutral attribute labels may be determined as the target attribute labels.

In another embodiment, a generation requirement for the speech feature description corresponding to the target speech data may be acquired. According to the generation requirement, the target speech attribute label may be determined from the plurality of speech attribute labels. The generation requirement for the speech feature description may be user-input or determined according to application scenario requirements, which is not limited herein.

For example, if the generation requirement for the speech feature description is to describe the speaker's accent, speech rate, and emotion, then speech attribute labels related to accent, speech rate, and emotion may be determined from the plurality of speech attribute labels as the target speech attribute labels.

Step 104: generating natural language description information corresponding to the target speech data according to the target speech attribute label.

The natural language description information may be used to describe speech features of the target speech data, such as volume features, speech rate features, timbre features, emotional features, etc.

Exemplarily, the natural language description information may be in text form or speech form, which is not limited herein.

Exemplarily, a large model may be used to generate the natural language description information according to the target speech attribute label.

In an embodiment, prompt information may be generated according to the target speech attribute label and feature description requirements. A large model may then be used to process the prompt information to generate the natural language description information. The prompt information is used to instruct the large model to generate a natural language description for describing speech features. The feature description requirements may include, but are not limited to, word count requirements and output format requirements for the natural language description information.

For example, if the target speech attribute labels include high volume and fast speech rate, the generated natural language description information may be “The speaker's volume is high, and the speech rate is fast.”

Exemplarily, after generating the natural language description information, the natural language description information may be displayed or pushed to a corresponding associated object.

The method for generating a speech feature description according to embodiments of the present disclosure can be applied in various scenarios.

In an embodiment, the present disclosure may be applied in customer service scenarios. The generated natural language description information of speech can be used to accurately assess the user's emotional state, etc., thereby providing personalized service.

In an embodiment, the present disclosure may be applied in intelligent education scenarios. For instance, teachers can understand students' emotional fluctuations, speech rate changes, etc., through the natural language description information of students' speech, thereby providing teachers with personalized teaching feedback.

In the embodiments of the present disclosure, by recognizing the target speech data to obtain a plurality of speech attribute labels, determining a target speech attribute label from the plurality of speech attribute labels to filter the speech attribute labels, and generating natural language description information for describing speech features of the target speech data based on the filtered target speech attribute label, redundant descriptions can be reduced, and the accuracy and conciseness of the description can be improved.

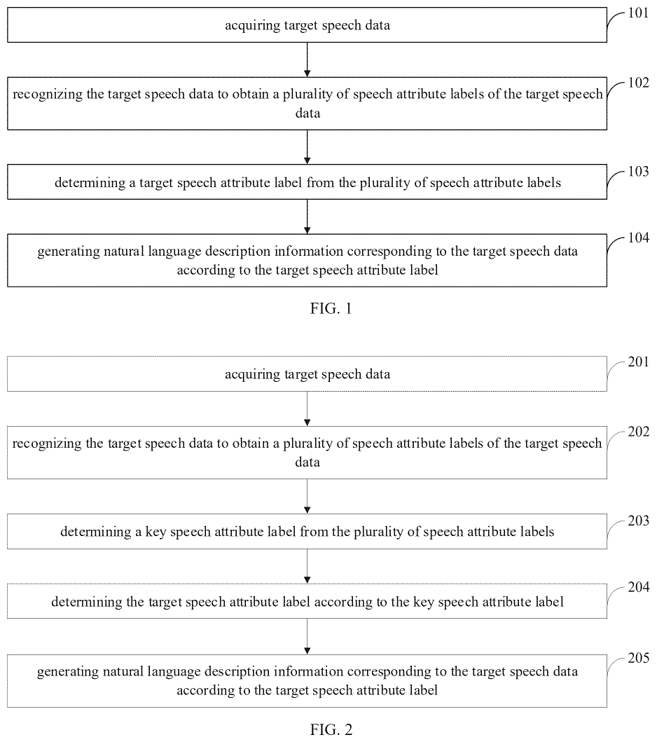

FIG. 2 is a schematic flowchart of a method for generating a speech feature description according to another embodiment of the present disclosure.

As shown in FIG. 2, the method for generating a speech feature description includes:

Step 201: acquiring target speech data.

Step 202: recognizing the target speech data to obtain a plurality of speech attribute labels of the target speech data.

In the present disclosure, for Steps 201-202, reference may be made to any implementation in the embodiments of the present disclosure, and thus details are not repeated here.

Step 203: determining a key speech attribute label from the plurality of speech attribute labels.

A key speech attribute label may be understood as an important attribute label used to describe and distinguish speech features, or a key speech attribute label may be understood as an attribute label used to identify key speech features.

For example, the key speech attribute label may include, but is not limited to, fast speech rate, high volume, high pitch, happiness, anger, etc.

In an embodiment, if a quantized value corresponding to a second speech attribute label among the plurality of speech attribute labels is greater than a corresponding first threshold, the second speech attribute label may be determined as the key speech attribute label.

For example, if the second speech attribute label is high volume, and the second speech corresponding quantized value is 100 dB, which is greater than a preset value of 90 dB, then high volume may be determined as the key speech attribute label.

It can be understood that different second speech attribute labels may correspond to different first thresholds, which is not limited herein.

Thus, the method of filtering key speech attribute labels based on the comparison between the quantized value corresponding to a speech attribute label and the corresponding first threshold is simple. Generating natural language description information based on the filtered speech attribute labels can improve the naturalness and information focus of the natural language description information. Moreover, by adjusting the threshold, different filtering requirements can be met.

In another embodiment, the key speech attribute label from the plurality of speech attribute labels are determined by determining whether a speech attribute label belongs to an enhanced attribute label. If a third speech attribute label among the plurality of speech attribute labels belongs to an enhanced attribute label, the third speech attribute label may be determined as the key speech attribute label.

The enhanced attribute label may refer to a speech attribute label that needs to be emphasized. Exemplarily, enhanced attribute labels may be preset.

For example, the enhanced attribute labels may include various emotion labels, low volume, high volume, fast speech rate, low pitch, high pitch, etc.

Thus, by determining speech attribute labels that belong to enhanced attribute labels as key speech attribute labels, the speech attribute labels requiring attention can be filtered out, and non-significant features can be pruned. Generating natural language description information based on the filtered speech attribute labels can retain the key speech features in the target speech data, thereby improving the naturalness and information focus of the natural language description information.

It should be noted that any one of the above methods or both methods may be adopted to filter key speech attribute labels, which is not limited herein.

Step 204: determining the target speech attribute label according to the key speech attribute label.

Exemplarily, the key speech attribute label may be directly determined as the target speech attribute label.

Exemplarily, the target speech attribute label may be determined according to the historical occurrence rate of the key speech attribute labels. For example, the top predetermined number of speech attribute labels with the highest historical occurrence rate among the key speech attribute labels may be determined as the target speech attribute labels. Thus, the accuracy of the target speech attribute labels can be improved.

Step 205: generating natural language description information corresponding to the target speech data according to the target speech attribute label.

In the present disclosure, for Step 205, reference may be made to any implementation in the embodiments of the present disclosure, and thus details are not repeated here.

In the embodiments of the present disclosure, by determining a key speech attribute label from the plurality of speech attribute labels, determining the target speech attribute label based on the key speech attribute label, and generating natural language description information based on the target speech attribute label, the natural language description information can include key speech features, thereby improving the information focus and accuracy of the description.

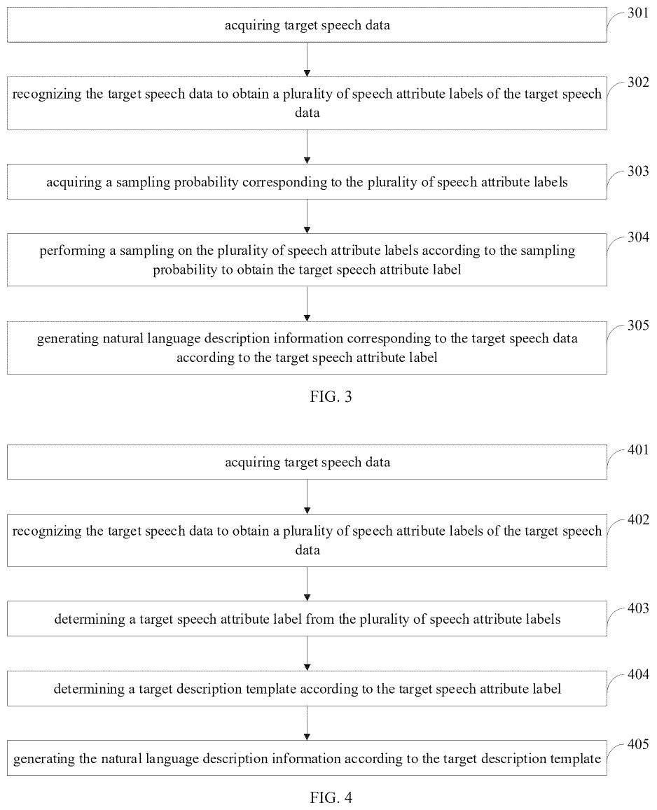

FIG. 3 is a schematic flowchart of a method for generating a speech feature description according to another embodiment of the present disclosure.

As shown in FIG. 3, the method for generating a speech feature description includes:

Step 301: acquiring target speech data.

Step 302: recognizing the target speech data to obtain a plurality of speech attribute labels of the target speech data.

In the present disclosure, for Steps 301-302, reference may be made to any implementation in the embodiments of the present disclosure, and thus details are not repeated here.

Step 303: acquiring a sampling probability corresponding to the speech attribute labels.

In the present disclosure, each speech attribute label has a corresponding sampling probability. The sampling probabilities for different speech attribute labels may be the same or different, which is not limited herein.

Exemplarily, the sampling probability corresponding to a speech attribute label may be determined according to the occurrence frequency of the speech attribute label in historical data. For example, a higher occurrence frequency may correspond to a higher sampling probability. The occurrence frequency in historical data may refer to the frequency at which the speech attribute label appears in previously generated natural language description information for speech.

It should be noted that the sampling probability corresponding to each speech attribute label may be fixed or obtained through updating, which is not limited herein.

The plurality of speech attribute labels may include neutral attribute labels, such as normal speech rate, normal volume, etc. In order to reduce the probability of neutral attribute labels being selected, exemplarily, neutral attribute labels among the plurality of speech attribute labels are identified. If a first speech attribute label among the plurality of speech attribute labels is a neutral attribute label, an initial sampling probability of the first speech attribute label may be updated according to a quantized value corresponding to the first speech attribute label, to obtain the sampling probability.

Here, the updated sampling probability is less than the initial sampling probability.

Specifically, the quantized value corresponding to the first speech attribute label may refer to the quantized value of the speech attribute to which the first speech attribute label belongs.

Exemplarily, the sampling probability p of the first speech attribute may be calculated using the following formula (1):

$$p = \frac{1}{1 + {e}^{- k ( x - 50 )}} \qquad ( 1 )$$

where k represents an adjustment coefficient, and x represents the quantized value corresponding to the first speech attribute.

Assume that a speech rate value falls within [40%, 60%], and the corresponding speech rate label is normal speech rate. For example, if the speech rate value of the target speech data is 45%, then the corresponding speech rate label is normal speech rate. Normal speech rate belongs to a neutral attribute label, and the normal speech rate corresponding quantized value is 45%. Then, based on the above formula (1), the sampling probability corresponding to the normal speech rate can be calculated, and the initial sampling probability corresponding to the normal speech rate is updated by replacing the initial sampling probability with the calculated sampling probability.

Thus, for neutral attribute labels among the plurality of speech attribute labels, a sampling probability less than the initial sampling probability can be obtained through updating based on the quantized value corresponding to the neutral attribute label, which reduces the probability of neutral attribute labels being selected, thereby filtering out non-significant speech features, increasing attention to significant speech features, and consequently enhancing the naturalness and information focus of the natural language description.

Step 304: performing a sampling on the plurality of speech attribute labels according to the sampling probability to obtain the target speech attribute label.

In the present disclosure, a sampling may be performed on the plurality of speech attribute labels according to the sampling probabilities of the plurality of speech attribute labels of the target speech data and a sampling quantity, to obtain the target speech attribute label.

For example, if there are seven speech attribute labels for the target speech data and the sampling quantity is two, then based on the sampling probabilities of the seven speech attribute labels, two speech attribute labels may be selected for generating the natural language description.

It should be noted that the sampling quantity may be set or determined according to actual needs, which is not limited herein.

Step 305: generating natural language description information corresponding to the target speech data according to the target speech attribute label.

In the present disclosure, Step 305 may adopt any implementation described in the embodiments of the present disclosure, and thus details are not repeated here.

In the embodiments of the present disclosure, by performing sampling on the plurality of speech attribute labels based on the sampling probabilities of the plurality of speech attribute labels to obtain the target attribute label, the target speech attribute label can be located more quickly, thereby improving the generation efficiency of the natural language description information.

FIG. 4 is a schematic flowchart of a method for generating a speech feature description according to another embodiment of the present disclosure.

As shown in FIG. 4, the method for generating a speech feature description includes:

Step 401: acquiring target speech data.

Step 402: recognizing the target speech data to obtain a plurality of speech attribute labels of the target speech data.

Step 403: determining a target speech attribute label from the plurality of speech attribute labels.

In the present disclosure, for Steps 401-403, reference may be made to any implementation in the embodiments of the present disclosure, and thus details are not repeated here.

Step 404: determining a target description template according to the target speech attribute label.

Here, a description template may refer to a template used for describing speech features. Exemplarily, a description template may be a complete piece of natural language description information, or a natural language description with slot markers, which is not limited herein.

For example, one description template is “The speaker's speech rate is [speech rate], and the emotion is [emotion]”. The template includes two slots: [speech rate] and [emotion].

In an embodiment, at least one template category is provided. Each template category has corresponding description templates. A target template category may be determined from the at least one template category according to the target speech attribute label, and then the target description template may be determined from the description templates corresponding to the target template category.

Exemplarily, the target speech attribute label may be matched with description information of each template category to determine the target template category that matches the target speech attribute label.

Exemplarily, various speech attributes may be combined to obtain a plurality of speech attribute combinations. Each speech attribute combination may used as a template category. The target speech attribute combination may be determined according to the target speech attribute label, and the template category corresponding to the target speech attribute combination may be used as the target template category.

For example, speech attribute combinations may include speech rate-emotion, speech rate-emotion-age, pitch-speech rate-emotion, etc. If the target speech attribute labels include fast speech rate and intense emotion, then the corresponding speech attribute combination is speech rate-emotion. Thus, the category corresponding to speech rate-emotion is the target template category.

Exemplarily, one or several templates may be randomly selected from the description templates corresponding to the target template category as the target description template. Alternatively, sampling may be performed on the description templates according to the sampling probabilities of the description templates corresponding to the target template category to determine the target description template. Alternatively, based on the historical usage rates of each description template corresponding to the target template category, a predetermined number of templates with the highest historical usage rates may be selected as the target description template.

Thus, by selecting the target template category according to the target speech attribute label, and then determining the target description template from the description templates corresponding to the target template category, the accuracy of the selected description template can be improved, thereby enhancing the accuracy of the natural language description information.

Optionally, for each speech attribute combination, a large model may be used to generate description templates under the template category corresponding to the speech attribute combination. Thereby, the diversity of description templates can be improved.

Step 405: generating the natural language description information according to the target description template.

In the present disclosure, the natural language description may be generated according to the target description template and the target speech attribute label.

In an embodiment, slot filling may be performed on the target description template using the target speech attribute label to obtain the natural language description information.

In another embodiment, a synonym library may be pre-constructed for each speech attribute label. A target synonym for the target speech attribute label may be determined from the synonym library corresponding to the target speech attribute label. Slot filling may then be performed on the target description template according to the target synonym to obtain the natural language description information.

For example, the speech attribute label is high pitch, and the speech attribute label corresponding synonym library is {sharp, high-pitched, piercing}. If the target speech attribute label includes high pitch, a synonym such as sharp may be selected from the synonym library for generating the natural language description.

For example, the speech attribute label is fast speech rate, and the speech attribute label corresponding synonym library is {like a string of firecrackers, like rapid fire, nonstop}. If the target speech attribute label includes fast speech rate, a synonym such as like rapid fire may be selected from the synonym library for generating the natural language description.

Exemplarily, a synonym may be randomly selected from the synonym library corresponding to the target speech attribute label as the target synonym for generating the natural language description information. Alternatively, sampling may be performed according to the sampling probabilities of each synonym in the synonym library to obtain the target synonym. Specifically, the sampling probability of a synonym may be fixed or updated according to a historical usage frequency of a synonym, which is not limited herein.

Thus, by selecting the target synonym from the synonym library corresponding to the target speech attribute label for generating the natural language description information, the repeated use of the same vocabulary can be reduced, thereby making the description more diverse and vivid, and improving the diversity and flexibility of the description.

Exemplarily, for each speech attribute label, a large model may be used to generate synonyms corresponding to the speech attribute label, and a synonym library may be constructed based on the generated synonyms, thereby expanding the coverage of the synonym library to meet different description needs.

For example, for different speech rate labels such as slow speech rate, fast speech rate, and normal speech rate, corresponding synonym libraries can be constructed, thereby improving the delicacy and diversity of descriptions.

Since some attribute combinations co-occur with relatively high frequency, there may be situations where description templates are repeatedly invoked. Based on this, exemplarily, historical speech feature description data may be acquired. The co-occurrence frequencies corresponding respectively to speech attribute combination may be determined according to the historical speech feature description data. For any speech attribute combination whose co-occurrence frequency is greater than a second threshold, description templates for the template category corresponding to that speech attribute combination may be generated according to the co-occurrence frequency.

Here, historical speech feature description data may refer to previously generated natural language description information used for describing speech features of speech data.

Exemplarily, the number of templates may be determined according to the co-occurrence frequency. Then, based on the speech attribute combination, a corresponding number of differentiated description templates may be generated, thereby high-frequency attribute combinations can avoid repeated invocation of the templates.

For example, if the co-occurrence frequency of speech rate and emotion is greater than the second threshold, then the number of templates N for the template category corresponding to the speech attribute combination may be calculated as N=log (co-occurrence frequency)×base. A large model may then be used to generate N differentiated description templates.

Thus, for speech attribute combinations with relatively high co-occurrence frequency, description templates for the template category corresponding to the speech attribute combination may be generated according to the co-occurrence frequency, thereby reducing the probability of repeated invocation of description templates for high-frequency attribute combinations and enriching the diversity of descriptions.

In the embodiments of the present disclosure, by determining the target description template according to the target speech attribute label, the accuracy of selecting the target description template can be improved. Generating the natural language description information based on the target description template achieves high generation efficiency.

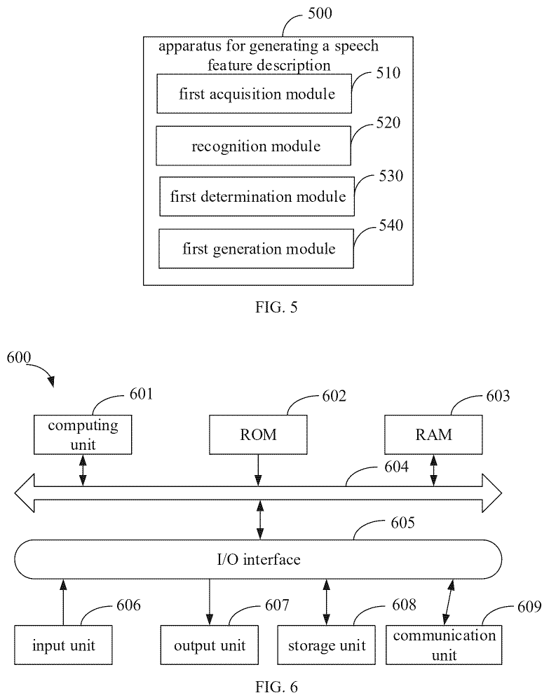

To implement the aforementioned embodiments, the embodiments of the present disclosure further provide an apparatus for generating a speech feature description. FIG. 5 is a schematic structural diagram of an apparatus for generating a speech feature description according to an embodiment of the present disclosure.

As shown in FIG. 5, the apparatus 500 for generating a speech feature description includes:
a first acquisition module 510, configured to acquire target speech data;
a recognition module 520, configured to recognize the target speech data to obtain a plurality of speech attribute labels of the target speech data;
a first determination module 530, configured to determine a target speech attribute label from the plurality of speech attribute labels;
a first generation module 540, configured to generate natural language description information corresponding to the target speech data according to the target speech attribute label, in which the natural language description information is used to describe speech features of the target speech data.

Optionally, the first determination module 530 is configured to:
determine a key speech attribute label from the plurality of speech attribute labels;
determine the target speech attribute label according to the key speech attribute label.

Optionally, the first determination module 530 is configured to perform at least one of the following:
in response to a quantized value corresponding to a second speech attribute label among the plurality of speech attribute labels being greater than a corresponding first threshold, determining the second speech attribute label as the key speech attribute label;
in response to a third speech attribute label among the plurality of speech attribute labels belonging to an enhanced attribute label, determining the third speech attribute label as the key speech attribute label.

Optionally, the first determination module 530 is configured to:
acquire a sampling probability corresponding to the plurality of speech attribute labels;
perform a sampling on the plurality of speech attribute labels according to the sampling probability to obtain the target speech attribute label.

Optionally, the first determination module 530 is configured to:
in response to determining that a first speech attribute label among the plurality of speech attribute labels being a neutral attribute label, update an initial sampling probability of the first speech attribute label according to a quantized value corresponding to the first speech attribute label, to obtain the sampling probability;
in which the sampling probability is less than the initial sampling probability.

Optionally, the first generation module 540 is configured to:
determine a target description template according to the target speech attribute label;
generate the natural language description information according to the target description template.

Optionally, the first generation module 540 is configured to:
determine a target synonym of the target speech attribute label from a synonym library corresponding to the target speech attribute label;
perform a slot filling on the target description template according to the target synonym to obtain the natural language description information.

Optionally, the first generation module 540 is configured to:
determine a target template category from at least one template category according to the target speech attribute label;
determine the target description template from description templates corresponding to the target template category.

Optionally, the apparatus may further comprise:
a second acquisition module, configured to acquire historical speech feature description data;
a second determination module, configured to determine co-occurrence frequencies corresponding respectively to speech attribute combinations according to the historical speech feature description data;
a second generation module, configured to, in response to the co-occurrence frequency of any one of the speech attribute combinations being greater than a second threshold, generate a description template of a template category corresponding to the speech attribute combination according to the co-occurrence frequency.

It should be noted that the explanations of the foregoing embodiments of the method for generating a speech feature description are also applicable to the apparatus for generating a speech feature description in this embodiment, and thus details are not repeated here.

In the embodiments of the present disclosure, by recognizing the target speech data to obtain a plurality of speech attribute labels, determining a target speech attribute label from the plurality of speech attribute labels to filter the speech attribute labels, and generating natural language description information for describing speech features of the target speech data based on the filtered target speech attribute label, redundant descriptions can be reduced, and the accuracy and conciseness of the description can be improved.

According to embodiments of the present disclosure, the present disclosure further provides an electronic device, a readable storage medium, and a computer program product.

FIG. 6 shows a schematic block diagram of an exemplary electronic device 600 that may be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital assistants, cellular phones, smartphones, wearable devices, and other similar computing devices. The components, their connections and relationships, and their functions shown herein are merely examples, and are not intended to limit the implementation of the present disclosure described and/or claimed herein.

As shown in FIG. 6, the device 600 includes a computing unit 601, which may perform various appropriate actions and processing according to computer programs stored in a ROM (Read-Only Memory) 602 or computer programs loaded from a storage unit 608 into a RAM (Random Access Memory) 603. Various programs and data required for the operation of the device 600 may also be stored in the RAM 603. The computing unit 601, the ROM 602, and the RAM 603 are connected to each other via a bus 604. An I/O (Input/Output) interface 605 is also connected to the bus 604.

Multiple components in the device 600 are connected to the I/O interface 605, including: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the device 600 to exchange information/data with other devices via computer networks such as the Internet and/or various telecommunication networks.

The computing unit 601 may be various general-purpose and/or special-purpose processing components with processing and computing capabilities. Some examples of the computing unit 601 include, but are not limited to, a CPU (Central Processing Unit), a GPU (Graphics Processing Unit), various dedicated AI (Artificial Intelligence) computing chips, various computing units that run machine learning model algorithms, a DSP (Digital Signal Processor), and any appropriate processor, controller, microcontroller, etc. The computing unit 601 executes the various methods and processes described above, such as the method for generating a speech feature description. For example, in some embodiments, the method for generating a speech feature description may be implemented as a computer software program tangibly contained in a machine-readable medium, such as the storage unit 608. In some embodiments, part or all of the computer program may be loaded and/or installed onto the device 600 via the ROM 602 and/or the communication unit 609. When the computer program is loaded into the RAM 603 and executed by the computing unit 601, one or more steps of the method for generating a speech feature description described above may be performed. Alternatively, in other embodiments, the computing unit 601 may be configured to perform the method for generating a speech feature description by any other suitable means (e.g., via firmware).

Various implementations of the systems and techniques described herein may be realized in digital electronic circuitry, integrated circuit systems, FPGAs (Field Programmable Gate Arrays), ASICs (Application-Specific Integrated Circuits), ASSPs (Application Specific Standard Products), systems on a chip (SOC), CPLDs (Complex Programmable Logic Devices), computer hardware, firmware, software, and/or combinations thereof. These various implementations may include: implementation in one or more computer programs that are executable and/or interpretable on a programmable system including at least one programmable processor, which may be a special-purpose or general-purpose programmable processor, receiving data and instructions from, and transmitting data and instructions to, a storage system, at least one input device, and at least one output device.

Program code for implementing the methods of the present disclosure may be written in any combination of one or more programming languages. These program codes may be provided to a processor or controller of a general-purpose computer, a special-purpose computer, or other programmable data processing apparatus, such that the program codes, when executed by the processor or controller, cause the functions/operations specified in the flowcharts and/or block diagrams to be implemented. The program codes may be executed entirely on the machine, partly on the machine, partly on the machine as a stand-alone software package and partly on a remote machine, or entirely on a remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer disk, a hard disk, a RAM, a ROM, an EPROM (Erasable Programmable Read-Only Memory) or Flash memory, an optical fiber, a CD-ROM (Compact Disc Read-Only Memory), an optical storage device, a magnetic storage device, or any suitable combination of the foregoing.

To provide for interaction with a user, the systems and techniques described here may be implemented on a computer having: a display device (e.g., a CRT (Cathode-Ray Tube) or LCD (Liquid Crystal Display) monitor) for displaying information to the user; and a keyboard and a pointing device (e.g., a mouse or a trackball) by which the user may provide input to the computer. Other kinds of devices may also be used for providing interaction with a user; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes back-end components (e.g., as a data server), or that includes middleware components (e.g., an application server), or that includes front-end components (e.g., a client computer having a graphical user interface or a Web browser through which a user may interact with an implementation of the systems and techniques described here), or any combination of such back-end, middleware, or front-end components. The components of the system may be interconnected by any form or medium of digital data communication (e.g., a communication network). Examples of communication networks include: a LAN (Local Area Network), a WAN (Wide Area Network), the Internet, and blockchain networks.

The computer system may include clients and servers. A client and server are generally remote from each other and typically interact through a communication network. The client-server relationship arises by virtue of computer programs running on the respective computers and having a client-server relationship to each other. The server may be a cloud server, also known as a cloud computing server or cloud host, which is a host product in a cloud computing service system, addressing the shortcomings of high management difficulty and weak business expansibility in traditional physical hosts and VPS services (“Virtual Private Server”). The server may also be a server of a distributed system, or a server incorporating blockchain.

According to embodiments of the present disclosure, the present disclosure further provides a computer program product. When instructions in the computer program product are executed by a processor, the method for generating a speech feature description proposed in the aforementioned embodiments of the present disclosure is performed.

It should be understood that the various forms of processes shown above may be used, with steps reordered, added, or deleted. For example, the steps described in the present disclosure may be performed in parallel, sequentially, or in a different order, provided that the desired results of the technical solutions disclosed in the present disclosure are achieved. No limitation is imposed herein.

The foregoing detailed description does not limit the scope of the present disclosure. Those skilled in the art should understand that various modifications, combinations, sub-combinations, and substitutions may be made according to design requirements and other factors. Any modifications, equivalent replacements, improvements, etc., made within the spirit and principles of the present disclosure shall be included within the scope of the present disclosure.

What is claimed is:

1. A method for generating a speech feature description, comprising:
acquiring target speech data;
recognizing the target speech data to obtain a plurality of speech attribute labels of the target speech data;
determining a target speech attribute label from the plurality of speech attribute labels; and
generating natural language description information corresponding to the target speech data according to the target speech attribute label, wherein the natural language description information is used to describe speech features of the target speech data.

2. The method according to claim 1, wherein determining the target speech attribute label from the plurality of speech attribute labels comprises:
determining a key speech attribute label from the plurality of speech attribute labels;
determining the target speech attribute label according to the key speech attribute label.

3. The method according to claim 2, wherein determining the key speech attribute label from the plurality of speech attribute labels comprises at least one of the following:
in response to a quantized value corresponding to a second speech attribute label among the plurality of speech attribute labels being greater than a corresponding first threshold, determining the second speech attribute label as the key speech attribute label; or
in response to a third speech attribute label among the plurality of speech attribute labels belonging to an enhanced attribute label, determining the third speech attribute label as the key speech attribute label.

4. The method according to claim 1, wherein determining the target speech attribute label from the plurality of speech attribute labels comprises:
acquiring a sampling probability corresponding to the plurality of speech attribute labels;
performing a sampling on the plurality of speech attribute labels according to the sampling probability to obtain the target speech attribute label.

5. The method according to claim 4, wherein acquiring the sampling probability corresponding to the plurality of speech attribute labels comprises:
in response to determining that a first speech attribute label among the plurality of speech attribute labels being a neutral attribute label, updating an initial sampling probability of the first speech attribute label according to a quantized value corresponding to the first speech attribute label, to obtain the sampling probability;
wherein the sampling probability is less than the initial sampling probability.

6. The method according to claim 1, wherein generating the natural language description information corresponding to the target speech data according to the target speech attribute label comprises:
determining a target description template according to the target speech attribute label;
generating the natural language description information according to the target description template.

7. The method according to claim 6, wherein generating the natural language description information according to the target description template comprises:
determining a target synonym of the target speech attribute label from a synonym library corresponding to the target speech attribute label;
performing a slot filling on the target description template according to the target synonym to obtain the natural language description information.

8. The method according to claim 6, wherein determining the target description template according to the target speech attribute label comprises:
determining a target template category from at least one template category according to the target speech attribute label;
determining the target description template from description templates corresponding to the target template category.

9. The method according to claim 8, further comprising:
acquiring historical speech feature description data;
determining co-occurrence frequencies corresponding respectively to speech attribute combinations according to the historical speech feature description data;
in response to the co-occurrence frequency of any one of the speech attribute combinations being greater than a second threshold, generating a description template of a template category corresponding to the speech attribute combination according to the co-occurrence frequency.

10. An apparatus for generating a speech feature description, comprising:
a first acquisition module, configured to acquire target speech data;
a recognition module, configured to recognize the target speech data to obtain a plurality of speech attribute labels of the target speech data;
a first determination module, configured to determine a target speech attribute label from the plurality of speech attribute labels; and
a first generation module, configured to generate natural language description information corresponding to the target speech data according to the target speech attribute label, wherein the natural language description information is used to describe speech features of the target speech data.

11. An electronic device, comprising:
at least one processor; and
a memory communicatively connected to the at least one processor, wherein the memory stores instructions executable by the at least one processor, and the instructions, when executed by the at least one processor, cause the at least one processor to perform:
acquiring target speech data;
recognizing the target speech data to obtain a plurality of speech attribute labels of the target speech data;
determining a target speech attribute label from the plurality of speech attribute labels; and
generating natural language description information corresponding to the target speech data according to the target speech attribute label, wherein the natural language description information is used to describe speech features of the target speech data.

12. A non-transitory computer-readable storage medium storing computer instructions, wherein the computer instructions are used to cause a computer to perform the method according to claim 1.

13. A computer program product, comprising a computer program, wherein the computer program, when executed by a processor, implements the method according to claim 1.
